(19) United States
(12) Patent Application Publication
(10) Pub. No.: US 2009/0234875 A1
(43) Pub. Date: Sep. 17, 2009

(54) SYSTEM AND METHODS FOR PROVIDING PRODUCT METRICS

(75) Inventors: Shiju Mathai, Carrollton, TX (US); James Paul Appleyard, North Richland Hills, TX (US)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 12/047,798

(22) Filed: Mar. 13, 2008

(51) Int. Cl. G06F 17/30; G06F 15/16

(52) U.S. Cl. 707/102; 709/203; 707/E17.008

(57) ABSTRACT

A system for providing product metrics is provided. The system includes a controller for accessing a plurality of network-connected information sites and retrieving from the information sites information pertaining to a specified product. The system also includes a database communicatively linked to the controller for storing the information pertaining to the specified product. Additionally, the system includes a data analyzer communicatively linked to the database for generating a plurality of product metrics corresponding to the specified product based upon the stored information. The system further includes a transaction registry communicatively linked to the data analyzer for selecting and organizing the product metrics.

### FIELD OF THE INVENTION

The present invention is related to the field of data processing, and more particularly, to techniques for processing data for generating and presenting product metrics.

### BACKGROUND OF THE INVENTION

Businesses and consumers conducting Business-to-Business (B2B) and Business-to-Consumer (B2C) transactions over the Internet or other data communications network, as well as at conventional bricks-and-mortar stores, typically desire real-time information about a product prior to deciding whether to purchase the product. With conventional techniques, however, a prospective purchaser must search out a number of disparage sources for the desired information.

The search for relevant product information, accordingly, can be a tedious task, which requires a business or consumer to expend considerable time and effort to obtain the information. Because there is as yet no mechanism for providing a condensed, real-time array of information, businesses and consumers typically must consult a number of different sources to obtain information about price, purchases, returns, exchanges, sales volumes, consumer ratings, and a host of other information that could advantageously be used in deciding whether to purchase a particular product.

### SUMMARY OF THE INVENTION

The present invention is directed to a system, method, and computer product for providing product metrics. Additionally, the system, method, and computer product can provide detailed analyzes of product-related information.

One embodiment is a system for providing product metrics. The system can include a controller for accessing a plurality of network-connected information sites and for retrieving from the information sites information pertaining to a specified product. The system can further include a database communicatively linked to the controller for storing the information pertaining to the specified product. Additionally, the system can include a data analyzer communicatively linked to the database for generating a plurality of product metrics corresponding to the specified product based upon the stored information. The system also can include a transaction registry communicatively linked to the data analyzer for selecting and organizing the product metrics.

Another embodiment is a computer-implemented method for providing product metrics. The method can include accessing a plurality of network-connected information sites and retrieving from the information sites information pertaining to a specified product. The method further can include generating a plurality of product metrics corresponding to the specified product based upon the retrieved information. The method also can include presenting at least a portion of the product metrics in response to a user request.

Still another embodiment is a computer-readable storage medium, such as an optical disk or magnetic tape, in which is embedded computer-readable code. The computer-readable code can be configured such that, when loaded on a computer, the computer-readable code causes the computer to perform the steps of: accessing a plurality of network-connected information sites and retrieving from the information sites information pertaining to a specified product; generating a plurality of product metrics corresponding to the specified product based upon the retrieved information; and presenting at least a portion of the product metrics in response to a user request.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for providing product metrics, according to one embodiment of the invention.

FIG. 2 is an exemplary view of dashboard views of product metrics generated by the system of FIG. 1.

FIG. 3 is an exemplary view of product metrics and detailed information generated by the system of FIG. 1.

FIG. 4 is a flowchart of exemplary steps in a method for providing product metrics, according yet another embodiment of the invention.

### DETAILED DESCRIPTION

The invention is directed to systems and methods for providing product information. With the invention, a consumer using a Web browser, a store-based computing system, or any other data communications channel has the option to get product metrics pertaining to a particular product before making a decision as to whether or not to purchase the product. The product metrics, more particularly, can be real-time metrics that are intermittently updated in response to new information.

According to a particular scenario, a first consumer makes an on-line or in-store purchase of a product. In response to the purchase, a repository of product information is updated with purchase information pertaining to the product. Subsequently, a second consumer can log into a merchant-maintained Website and, before deciding to purchase a unit of the same product item, click on or select an icon or other product identifier corresponding to the product so as to retrieve a condensed information summary of product-related information. The consumer thus can choose to retrieve real-time metrics, including yearly, monthly, weekly, or daily statistics about the product. As described more particularly, below, the consumer also can be afforded an opportunity to “drill down” into the details associated with different product metrics in order to retrieve more detailed product-specific information. Internal metrics specific to a particular product supplier can be provided, such as the number of units purchased, returned, and/or exchanged. External metrics such as commentaries about a product, as provided, for example, on blogs, government-sponsored Websites, and/or consumer group reports can likewise be provided.

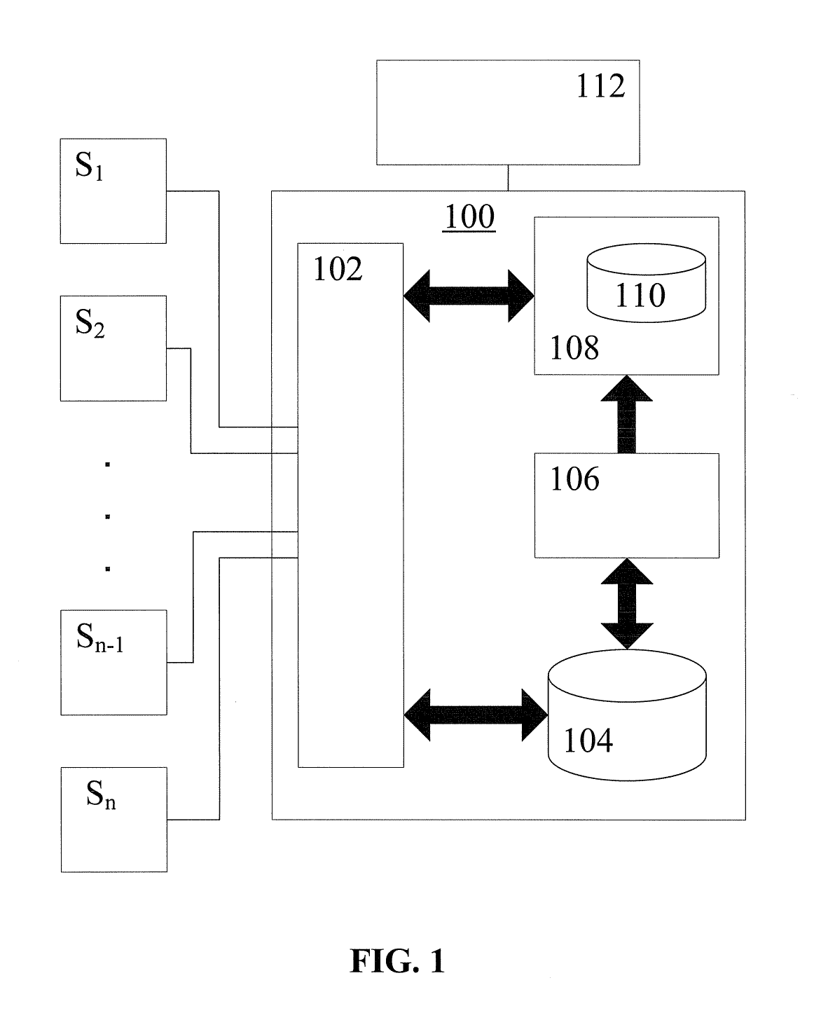

FIG. 1 is a schematic view of a system 100 for providing product metrics. The system illustratively includes a controller 102, a database 104 communicatively linked to the controller, a data analyzer 106 communicatively linked to the database, and a transaction registry 108 communicatively linked to the data analyzer. The controller 102 can be implemented in dedicated circuitry comprising, for example, registers, gates, and other logic-based circuitry for performing the functions described herein. The database 104 can be implemented in an electronic memory for storing electronic data. The data analyzer 106 and the transaction registry 108 can be implemented in dedicated circuitry and/or computer-executable code for also performing the various functions and procedures described herein.

Illustratively, the controller 102 connects directly, or through a data communications network (not explicitly shown), to a plurality of information sites, S₁, S₂, . . . , Sₙ₋₁, and Sₙ. The information sites S₁, S₂, . . . , Sₙ₋₁, and Sₙ can include, for example, one or more blogs maintained by individuals who provide comments about a product or products. Additionally, or alternatively, the information sites S₁, S₂, . . . , Sₙ₋₁, and Sₙ can include one or more merchant computer systems for facilitating transactions involving one or more products. The information sites S₁, S₂, . . . , Sₙ₋₁, and Sₙ also can include, for example, one or more government agency sites and/or consumer-reporting sites that provide information about one or more products. The plurality of sites S₁, S₂, . . . , Sₙ₋₁, and Sₙ likewise can include various sites offering reviews of and commentaries on one or more products. Indeed, any type of site that contains relevant information pertaining to a particular product can be accessed by the controller 102.

Accordingly, the controller 102 accesses the plurality of network-connected information sites S₁, S₂, . . . , Sₙ₋₁, and Sₙ and retrieves from the information sites information pertaining to a specified product. The database 104 communicatively linked to the controller 102 then stores the information pertaining to the specified product. The data analyzer 106 communicatively linked to the database 104 uses the information retrieved from the different information sites S₁, S₂, . . . , Sₙ₋₁, and Sₙ to generate a plurality of product metrics corresponding to the specified product. The transaction registry 108 communicatively linked to the data analyzer 106 selects and organizes the various product metrics.

Thus, operatively, the data analyzer 106 performs critical and extensive analysis of the data and information, and the results are stored in the transaction registry 108. The transaction registry 108 can select and organize the product metrics so as to show only condensed, relevant information. Extensive analyzes can be further organized into tables and/or graphs for a more detailed view of the product metrics. In operation, the controller 102 can manage requests for product metrics and well as direct responses to the requests. When a user performs a search for a product or browses an on-line catalog for the product, a request is sent to the system 100, which can be configured as a network or central repository server. The controller 102 receives the request and, if the request is for summary information or data, the controller conveys the request to the transaction registry 108, which contains the product metrics 110. The transaction registry 108 sends, through the controller 102, a response to a user system 112, which can also be connected directly or through a data communications network to the system 100. The response can comprise critical real-time summary data in the form of the product metrics 110.

Additionally, the transaction registry 108 can send a uniform resource identifier (URI), which as will be readily understood by one of ordinary skill, can comprises a character string by which network resources can be contacted. In this manner, detailed analysis of data corresponding to a particular metric can be obtained along with the response, thereby permitting a user to drill down for more detailed product information.

When a unit of the product is purchased, either at a bricks-and-mortar store or through an on-line Web site, the purchase request is sent to the controller 102. The controller 102 stores the transaction-related data in the database 104 and automatically triggers the data analyzer 106. The data analyzer 106 performs critical and extensive analysis on the data. Critical analysis or a condensed view of summary product metrics can be stored in tables of the transaction registry 108. Extensive analysis can be performed by the data analyzer 106 and stored as graphs or tables in the transaction registry 108.

When a product return or exchange request occurs, again, either at a bricks-and-mortar store or through an on-line Web site, the request is sent to the controller 102. The controller 102 updates the database 104 accordingly and automatically triggers the data analyzer 106. The data analyzer 106 performs critical and extensive analysis of the relevant data. Critical analysis or a condensed view of summary product metrics are updated in graphs and/or tables of the transaction registry 108.

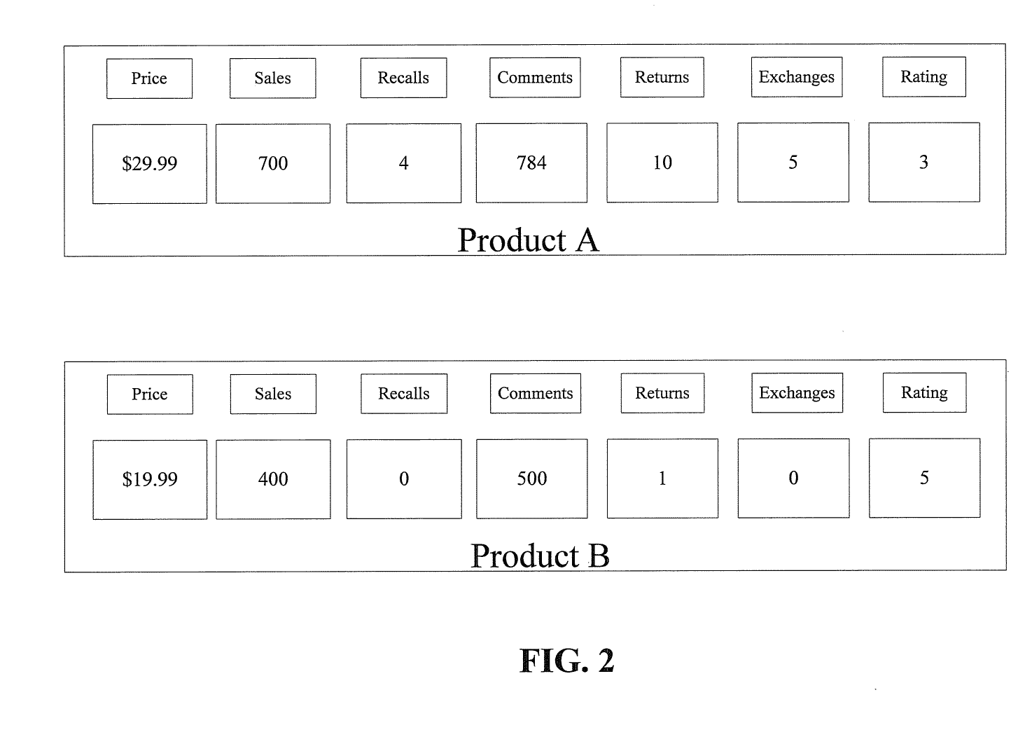

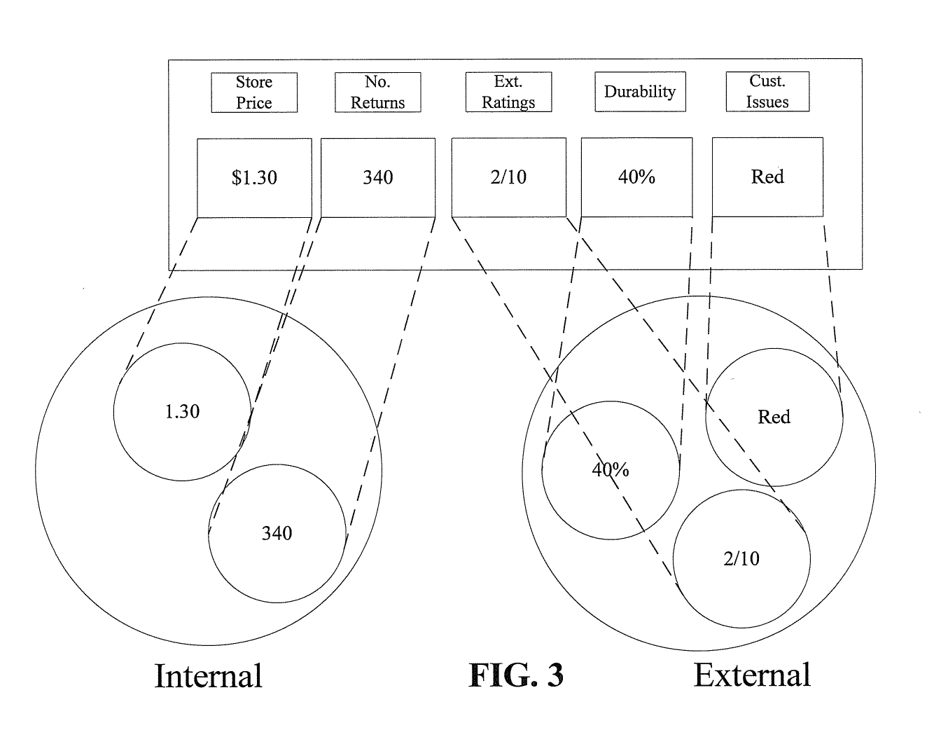

Referring additionally to FIG. 2, exemplary dashboard views of product metrics generated by the system 100 are shown. The views can be displayed, for example, on a display screen of a user system 112 that is communicatively linked to the system 100. Illustratively, the product metrics contained in the condensed, dashboard views include the price of a product, total sales, number of recalls, number of customer or other comments, number of returns of the product, number of exchanges, and product rating. In FIG. 3, below a dashboard view, is a pictorial representation of the origination of the source of the product metrics, comprising both internal metrics (i.e., internal to a particular store or merchant) and external metrics (i.e., metrics obtained from other sources, such a consumer ratings and comments, or government statistics).

As the exemplary views demonstrate, the system provides a user with a condensed view of real-time key metrics of a product. This can provide consumers with rapid selection and drill-down views of metrics needed to make informed product purchasing decisions. The metrics can be retrieved from multiple sources, both internal and external. The product summary allows for faster product selection by displaying multiple condensed metrics from any source in a single view, which can be specified by a user profile that dictates which among a plurality of metrics that a particular user finds most informative or relevant.

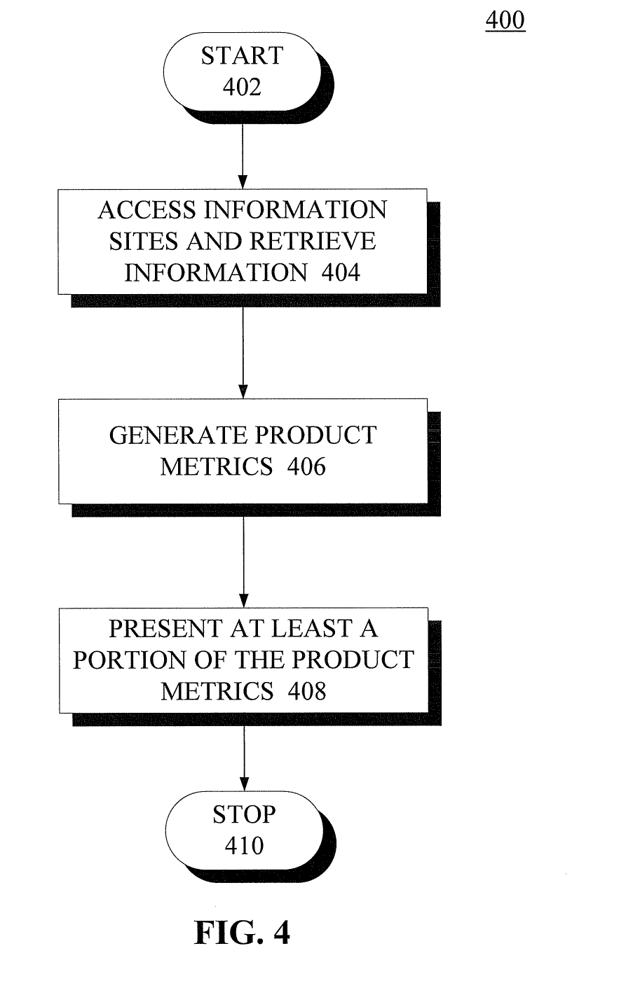

FIG. 4 is a flowchart of exemplary steps in a method 400 for providing product metrics, according to another embodiment of the invention. The method 400 includes, after the start at step 402, accessing a plurality of network-connected information sites and retrieving from the information sites information pertaining to a specified product at step 404. The method 400 further includes, at step 406, generating a plurality of product metrics corresponding to the specified product based upon the retrieved information. Additionally, the method 400 includes presenting at least a portion of the product metrics in response to a user request at step 408. The method 400 illustratively concludes at step 410.

Optionally, according to another embodiment, the method 400 can further include presenting detailed product information in response to a user selecting a particular product metric from among the portion of product metrics presented. According to still another embodiment, the method 400 can further include constructing a user profile specifying one or more product attributes pertaining to the specified product. Moreover, the portion of product metrics presented can be selected from among the plurality of product metrics based upon the user profile.

According to a particular embodiment of the method 400, generating the plurality of product metrics can comprise determining one or more of the following: a number of units of the specified product purchased, a number of units of the specified product exchanged for alternate products, and a number of units of the specified product returned within a predetermined time period.

The method 400, according to still another embodiment, can further comprise intermittently accessing the plurality of network-connected information sites and retrieving from the information sites updated information pertaining to the specified product. The method 400, accordingly, can also include intermittently revising one or more of the plurality of product metrics based upon the updated information.

According to yet another embodiment, the method 400 can include presenting at least a portion of the product metrics on a display screen. More particularly, the method 400 can comprise presenting on a display screen a condensed dashboard view of the portion of the product metrics.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, such as an optical disk or magnetic tape, in which is embedded computer-readable code for causing a computer to implement the methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method for providing product metrics, the method comprising:
accessing a plurality of network-connected information sites and retrieving from the information sites information pertaining to a specified product;
generating a plurality of product metrics corresponding to the specified product based upon the retrieved information; and
presenting at least a portion of the product metrics in response to a user request.

2. The method of claim 1, further comprising presenting detailed product information in response to a user selecting a particular product metric from among the portion of product metrics presented.

3. The method of claim 1, further comprising constructing a user profile specifying one or more product attributes pertaining to the specified product.

4. The method of claim 3, wherein the portion of product metrics presented are selected from among the plurality of product metrics based upon the user profile.

5. The method of claim 1, wherein generating the plurality of product metrics comprises determining at least one among a number of units of the specified product purchased, a number of units of the specified product exchanged for alternate products, and a number of units of the specified product returned within a predetermined time period.

6. The method of claim 1, further comprising intermittently accessing the plurality of network-connected information sites and retrieving from the information sites updated information pertaining to the specified product.

7. The method of claim 6, further comprising intermittently revising one or more of the plurality of product metrics based upon the updated information.

8. The method of claim 1, wherein presenting at least a portion of the product metrics comprises presenting on a display screen a condensed dashboard view of the portion of the product metrics.

9. A system for providing product metrics, the system comprising:
a controller for accessing a plurality of network-connected information sites and retrieving from the information sites information pertaining to a specified product;
a database communicatively linked to the controller for storing the information pertaining to the specified product;
a data analyzer communicatively linked to the database for generating a plurality of product metrics corresponding to the specified product based upon the stored information; and
a transaction registry communicatively linked to the data analyzer for selecting and organizing the product metrics.

10. The system of claim 9, wherein the controller is configured to respond to a product search request from a user by sending the request to the transaction registry, which is configured to respond to the request by presenting at least a portion of the product metrics to the user.

11. The system 9, wherein the controller is configured to respond to a request for detailed product information from a user by sending the request to the transaction registry, which is configured to respond to the request by conveying a uniform resource identifier to the user.

12. The system 9, wherein the controller is configured to detect a product transaction comprising at least one among a purchase of a unit of the specified product, a return of a unit of the specified product, and an exchange of the specified product for an alternate product, and wherein, in response to the detected transaction, the data analyzer analyzes the transaction and stores transaction-related information in the transaction registry.

13. A computer-readable storage medium in which is embedded computer-readable code that when loaded on a computer causes the computer to perform the steps of:
accessing a plurality of network-connected information sites and retrieving from the information sites information pertaining to a specified product;
generating a plurality of product metrics corresponding to the specified product based upon the retrieved information; and
presenting at least a portion of the product metrics in response to a user request.

14. The computer-readable storage medium of claim 13, further comprising computer-readable code for causing the computer to present detailed product information in response to a user selecting a particular product metric from among the portion of product metrics presented.

15. The computer-readable storage medium of claim 13, further comprising computer-readable code for causing the computer to construct a user profile specifying one or more product attributes pertaining to the specified product.

16. The computer-readable storage medium of claim 15, wherein the portion of product metrics presented are selected from among the plurality of product metrics based upon the user profile.

17. The computer-readable storage medium of claim 13, wherein generating the plurality of product metrics comprises determining at least one among a number of units of the specified product purchased, a number of units of the specified product exchanged for alternate products, and a number of units of the specified product returned within a predetermined time period.

18. computer-readable storage medium of claim 13, further comprising computer-readable code for causing the computer to intermittently access the plurality of network-connected information sites and retrieve from the information sites updated information pertaining to the specified product.

19. The computer-readable storage medium of claim 18, further comprising computer-readable code for causing the computer to intermittently revise one or more of the plurality of product metrics based upon the updated information.

20. The computer-readable storage medium of claim 13, wherein presenting at least a portion of the product metrics comprises presenting on a display screen a condensed dashboard view of the portion of the product metrics.
